(19) United States
(12) Patent Application Publication
(10) Pub. No.: US 2026/0105084 A1
(43) Pub. Date: Apr. 16, 2026

(54) LARGE LANGUAGE MODEL (LLM) INTERACTION METHOD AND SYSTEM

(71) Applicant: Yin YU, Fuzhou (CN)

(72) Inventors: Yin YU, Fuzhou (CN); Ziyan YANG, Fuzhou (CN)

(21) Appl. No.: 19/422,588

(22) Filed: Dec. 17, 2025

Related U.S. Application Data
(63) Continuation of application No. PCT/CN2024/106324, filed on Jul. 19, 2024.

(30) Foreign Application Priority Data
Mar. 20, 2024 (CN) 202410318110.6

(51) Int. Cl. G06F 16/3329; G06F 16/34; G06Q 30/0251; G06Q 30/0273

(52) U.S. Cl. CPC G06F 16/33295; G06F 16/345; G06Q 30/0251; G06Q 30/0275

(57) ABSTRACT

A large language model (LLM) interaction method and system are provided. A conversation input by a user is acquired. Retrieval and summarization are performed to obtain an answer retrieval result. Based on a conversation and a current user intent, marketing placement information is retrieved from a marketing database and summarized to obtain a marketing placement retrieval result. Comprehensive sorting is performed on cited sources of the answer retrieval result and the marketing placement retrieval result to obtain a sorted result, which is returned to the user as a cited source result. Summarization and integration are performed on the cited source result and the marketing placement retrieval result to obtain an answer result. The answer result is returned to the user. The user request, the answer result and the marketing retrieval result are integrated to obtain a recommended related question, which is returned to the user to guide further multi-turn dialogues.

### CROSS-REFERENCE TO RELATED APPLICATIONS

This application is a continuation of International Patent Application No. PCT/CN2024/106324, filed on July 19, 2024, which claims the benefit of priority from Chinese Patent Application No. 202410318110.6, filed on March 20, 2024. The content of the aforementioned application, including any intervening amendments made thereto, is incorporated herein by reference in its entirety.

### TECHNICAL FIELD

This application relates to large language models (LLMs), and more particularly to an LLM interaction method and system.

### BACKGROUND

With the development of large language model (LLM) technology, users can quickly obtain answers through interaction with LLMs. On the user side, when using chatbots or dialogue platforms developed with prompt engineering and retrieval augmentation, users can only receive straightforward response results within the constraints of limited chat memory windows and contextual dialogues. On the enterprise side, as the number of applications surges and dialogue platforms experience steep increases in traffic, enterprises are unable to effectively distribute marketing content to LLM users.

At present, the vast majority of LLM interaction systems are of the retrieval-augmented type. As shown in FIG. 1, these systems primarily rely on retrievals from local proprietary databases or third-party application programming interface (API) to realize interactive conversations involving proprietary content and real-time content. However, these systems have the following deficiencies. The answer results are plain text directly associated with the conversation request. In order to obtain more accurate answers, users need to describe their needs as accurately and in detail as possible.

Taking the Perplexity platform as an example, as one of the dialogue platforms with a relatively excellent user experience, the Perplexity platform supplements cited source information and related question feedback on the basis of traditional retrieval-augmented direct answering. This allows users to further understand the details of answers and simplifies the user interaction process for asking questions. The page screenshot and logical analysis structure are shown in FIGS. 2 and 3, respectively. The platform has the following deficiencies. The current result returned by the platform are content directly associated with the conversation request. It fails to further infer the user’s needs and intentions to provide service recommendations. The lack of marketing capabilities also restricts the platform’s business model to user subscription payments only.

### SUMMARY

An object of the disclosure is to provide a large language model (LLM) interaction method and system, which proposes marketing information retrieval augmentation on the basis of retrieval augmentation and source-based retrieval, so as to provide users with a better experience and meet the marketing requirements of enterprises.

In order to achieve the above object, the following technical solutions are adopted.

In a first aspect, this application provides an LLM interaction method, comprising:

(S1) acquiring a conversation input by a user, and parsing the conversation to obtain a user request;

(S2) performing retrieval and summarization according to the user request to obtain an answer retrieval result, wherein the answer retrieval result comprises a cited source link and a retrieved content; and

simultaneously performing comprehensive analysis on user personal setting information, third-party user profile information, historical dialogue information, a historical user intent and a current dialogue context followed by summarization and inference to obtain a current user intent; and based on the conversation and the current user intent, retrieving marketing placement information from a marketing database followed by summarization to obtain a marketing placement retrieval result, wherein the marketing placement retrieval result comprises a placement link, a placement content, a placement type and a placement strategy;

(S3) according to a link weight of the answer retrieval result, a link weight of the marketing placement retrieval result and a bidding price of the marketing placement retrieval result, performing comprehensive sorting on a cited source of the answer retrieval result and a cited source of the marketing placement retrieval result to obtain a sorted result, and returning the sorted result to the user as a cited source result;

(S4) performing summarization and integration on the cited source result and the marketing placement retrieval result to obtain an answer result, and returning the answer result to the user; and

(S5) integrating the user request, the answer result and the marketing placement retrieval result to obtain a recommended related question, and returning the recommended related question to the user to guide a further multi-turn dialogue.

In a second aspect, this application provides an LLM interaction system, comprising:

a conversation parsing module;

a retrieval module;

a marketing placement module;

a first generation module;

a second generation module; and

a third generation module;

wherein the conversation parsing module is configured to acquire a conversation input by a user, and parse the conversation to obtain a user request;

the retrieval module is configured to perform retrieval and summarization according to the user request to obtain an answer retrieval result, and the answer retrieval result comprises a cited source link and a retrieved content;

the marketing placement module is configured to perform comprehensive analysis on user personal setting information, third-party user profile information, historical dialogue information, a historical user intent and a current dialogue context followed by summarization and inference to obtain a current user intent while the retrieval module performs retrieval, and retrieve marketing placement information from a marketing database followed by summarization to obtain a marketing placement retrieval result based on the conversation and the current user intent; and the marketing placement retrieval result comprises a placement link, a placement content, a placement type and a placement strategy;

the first generation module is configured to perform comprehensive sorting on a cited source of the answer retrieval result and a cited source of the marketing placement retrieval result to obtain a sorted result according to a link weight of the answer retrieval result, a link weight of the marketing placement retrieval result and a bidding price of the marketing placement retrieval result, and return the sorted result to the user as a cited source result;

the second generation module is configured to perform summarization and integration on the cited source result and the marketing placement retrieval result to obtain an answer result, and return the answer result to the user; and

the third generation module is configured to integrate the user request, the answer result and the marketing placement retrieval result to obtain a recommended related question, and return the recommended related question to the user to guide a further multi-turn dialogue.

Compared to the prior art, the present disclosure has the following beneficial effects.

The present disclosure integrates inference and retrieval capabilities of LLMs with personalized content generation to enhance user experience. Simultaneously, it meets the marketing demands of enterprise users by incorporating marketing information flow strategies and embedding marketing content into question-and-answer (Q&A) interactions. This enables broader and more efficient distribution of marketing content, expands the application methods of LLMs, and provides users with an improved experience while fulfilling the marketing requirements of enterprises.

The above description is only an overview of the technical solutions of the present disclosure. To enable a clearer understanding of the technical solutions of the present disclosure, implementations can be carried out in accordance with the content of the specification. Moreover, in order to understand the above objects, features and beneficial effects of the present disclosure more clearly, specific embodiments of the present disclosure will be described below.

### BRIEF DESCRIPTION OF THE DRAWINGS

The present disclosure will be further described below in conjunction with the accompanying drawings and embodiments.

FIG. 1 is a flow chart of a large language model (LLM) interaction method in the prior art;

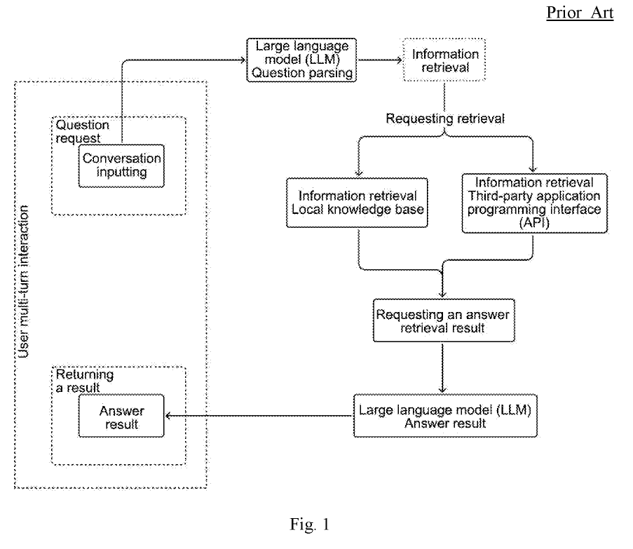

FIG. 2 is a schematic diagram of an interface of a Perplexity platform when returning a result in the prior art;

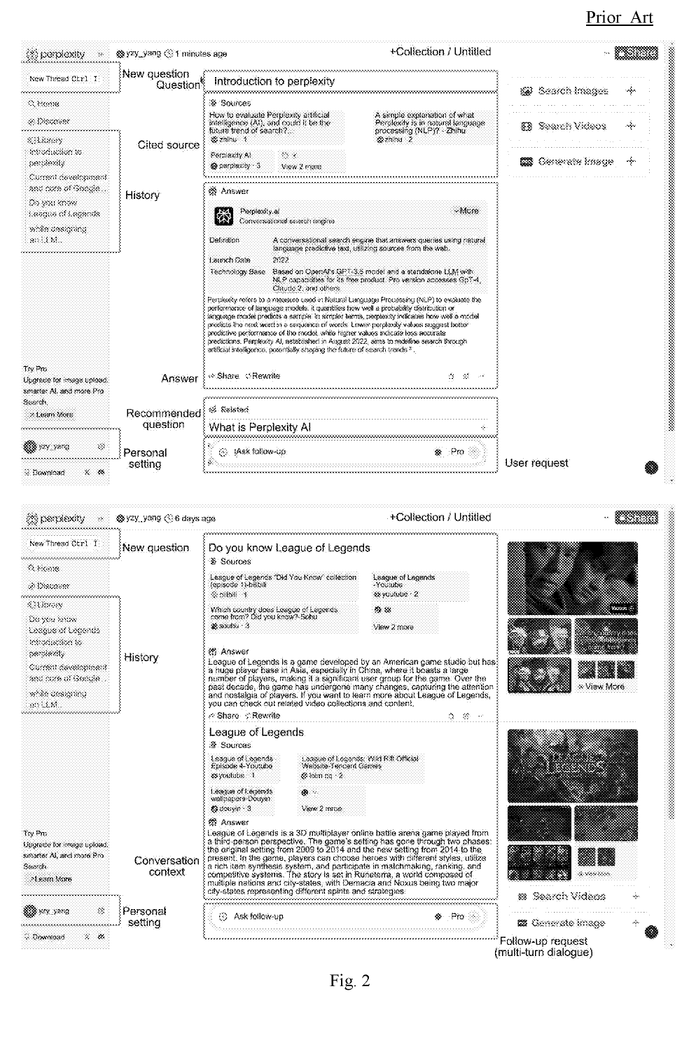

FIG. 3 is a flow chart of returning the result of the Perplexity platform in the prior art;

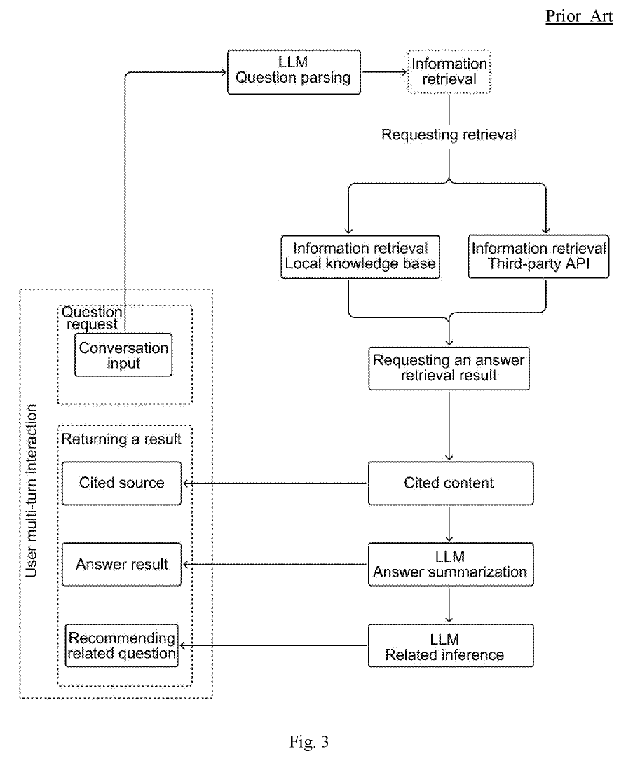

FIG. 4 is a flow chart of an LLM interaction method in accordance with an embodiment of the present disclosure; and

FIG. 5 is a schematic diagram of an LLM interaction system in accordance with an embodiment of the present disclosure.

### DETAILED DESCRIPTION OF EMBODIMENTS

The present disclosure provides a large language model (LLM) interaction method and system, which propose marketing information retrieval augmentation based on retrieval augmentation and source-based retrieval, so as to provide users a better experience while fulfilling the marketing requirements of enterprises.

The technical solution in the embodiments of the present disclosure follows the overall concept below. The present disclosure integrates reasoning and retrieval capabilities of LLMs with personalized content generation to enhance user experience. Simultaneously, it meets the marketing demands of enterprise users by incorporating marketing information flow strategies and embedding marketing content into question-and-answer (Q&A) interactions. This enables broader and more efficient distribution of marketing content, expands the application methods of LLMs, and provides users with an improved experience while fulfilling the marketing requirements of enterprises.

### EMBODIMENT 1

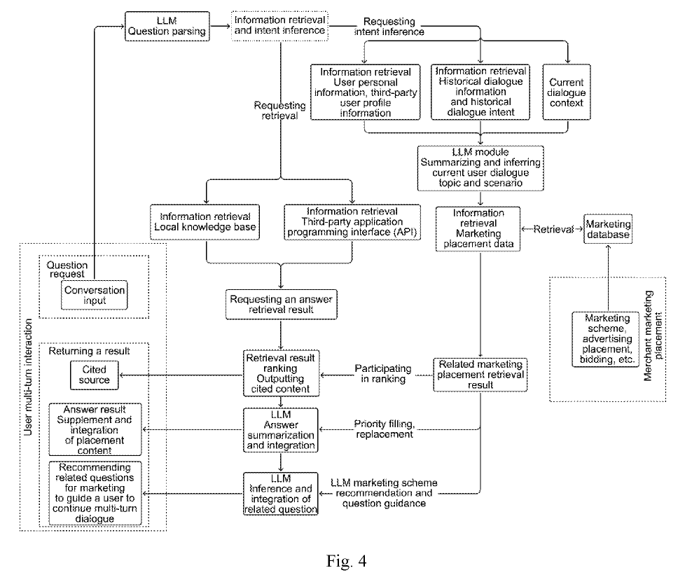

As shown in FIG. 4, an LLM interaction method is provided, which includes the following steps.

Step (S1) A conversation input by a user is acquired and parsed to obtain a user request.

Step (S2) Retrieval and summarization are performed according to the user request to obtain an answer retrieval result. The answer retrieval result includes a cited source link and a retrieved content.

Simultaneously, comprehensive analysis is performed on user personal setting information, third-party user profile information, historical dialogue information, a historical user intent and a current dialogue context followed by summarization and inference to obtain a current user intent. Based on the conversation and the current user intent, marketing placement information is retrieved from a marketing database and summarized to obtain a marketing placement retrieval result. The marketing placement retrieval result includes a placement link, a placement content, a placement type and a placement strategy.

Step (S3) According to a link weight of the answer retrieval result, a link weight of the marketing placement retrieval result and a bidding price of the marketing placement retrieval result, comprehensive sorting is performed on a cited source of the answer retrieval result and a cited source of the marketing placement retrieval result to obtain a sorted result. The sorted result is returned to the user as a cited source result. The comprehensive sorting includes the following steps.

Step (a1) Applicable to information site traffic guidance, when the user searches for certain information, a link weight ranking among similar information is increased.

Step (a2) Applicable to official link protection and traffic direction, based on official information protection and distribution of a latest marketing scheme, it is ensured that a result received by the user is latest official information.

Step (a3) Applicable to competitive traffic direction among same-category objects, rankings or channels, same-category products or services are recommended while answering a user’s question.

Step (S4) Summarization and integration are performed on the cited source result and the marketing placement retrieval result to obtain an answer result. The answer result is returned to the user. The summarization and integration are implemented based on the placement strategy, and include the following steps.

Step (b1) Additional information is supplemented based on intent inference, that is, service function docking is supplemented based on inference of the current user intent and a possible user service request intent.

Step (b2) A latest official marketing scheme is expanded and supplemented.

Step (b3) Same-category rankings, competing products, channel information and recommendation information are expanded and supplemented.

Step (S5) The user request, the answer result and the marketing retrieval result are integrated to obtain a recommended related question. The recommended related question is configured to integrate system-intent-based service function guidance, a guiding question for an official marketing scheme and a guiding question for same-category rankings, competing products, channel information and recommendation information.

The recommended related question is returned to the user to guide a further multi-turn dialogue.

Under the same inventive concept, the present disclosure also provides a device corresponding to the method in Embodiment 1, as detailed in Embodiment 2.

### EMBODIMENT 2

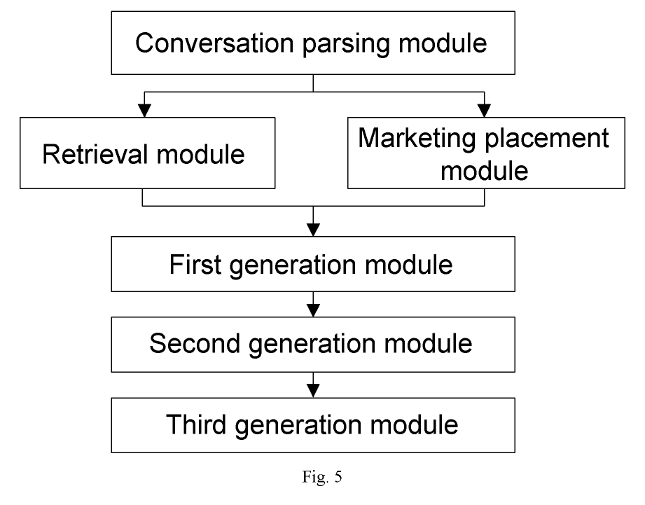

As shown in FIG. 5, an LLM interaction system is provided, including a conversation parsing module, a retrieval module, a marketing placement module, a first generation module, a second generation module and a third generation module.

The conversation parsing module is configured to acquire a conversation input by a user, and parse the conversation to obtain a user request.

The retrieval module is configured to perform retrieval and summarization according to the user request to obtain an answer retrieval result, and the answer retrieval result comprises a cited source link and a retrieved content.

The marketing placement module is configured to perform comprehensive analysis on user personal setting information, third-party user profile information, historical dialogue information, a historical user intent and a current dialogue context followed by summarization and inference to obtain a current user intent while the retrieval module performs retrieval, and retrieve marketing placement information from a marketing database followed by summarization to obtain a marketing placement retrieval result based on the conversation and the current user intent; and the marketing placement retrieval result comprises a placement link, a placement content, a placement type and a placement strategy.

The first generation module is configured to perform comprehensive sorting on a cited source of the answer retrieval result and a cited source of the marketing placement retrieval result to obtain a sorted result according to a link weight of the answer retrieval result, a link weight of the marketing placement retrieval result and a bidding price of the marketing placement retrieval result, and return the sorted result to the user as a cited source result. The comprehensive sorting includes the following steps.

(a1) Applicable to information site traffic guidance, when the user searches for certain information, a link weight ranking among similar information is increased.

(a2) Applicable to official link protection and traffic direction, based on official information protection and distribution of a latest marketing scheme, it is ensured that a result received by the user is latest official information.

(a3) Applicable to competitive traffic direction among same-category objects, rankings or channels, same-category products or services are recommended while answering a user’s question.

The second generation module is configured to perform summarization and integration on the cited source result and the marketing placement retrieval result to obtain an answer result, and return the answer result to the user. The summarization and integration are implemented based on the placement strategy, and include the following steps.

(b1) Additional information is supplemented based on intent inference, that is, service function docking is supplemented based on inference of the current user intent and a possible user service request intent.

(b2) A latest official marketing scheme is expanded and supplemented.

(b3) Same-category rankings, competing products, channel information and recommendation information are expanded and supplemented.

The third generation module is configured to integrate the user request, the answer result and the marketing placement retrieval result to obtain a recommended related question, and return the recommended related question to the user to guide a further multi-turn dialogue.

The recommended related question is configured to integrate system-intent-based service function guidance, a guiding question for an official marketing scheme and a guiding question for same-category rankings, competing products, channel information and recommendation information.

Since the system described in Embodiment 2 of the present disclosure is the system adopted for implementing the method of Embodiment 1 of the present disclosure, those skilled in the art can understand the specific structure and variations of the device based on the method described in Embodiment 1 of the present disclosure, and thus no further details will be provided herein. All devices adopted in the method of Embodiment 1 of the present disclosure shall fall within the scope of the present disclosure.

Examples of application scenarios of the present disclosure are provided below.

User profile includes:

User personal information setting: mother of two children;

User tags: loves life, loves gaming

The interaction process is carried out as follows.

(1) Interaction of inquiries about drug and test result

First round of interaction

“Amoxicillin” is input by the user.

The LLM platform (hereinafter “platform”) parses the user’s request, retrieves an answer, and infers the interaction intent. With no associated historical records, a scientific scenario is set as the default.

The platform returns the answer and information source: “Amoxicillin is a semi-synthetic broad-spectrum β-lactam antibiotic, mainly used to treat various infections caused by susceptible bacteria. The following is key information about Amoxicillin. Mechanism of action: xxx. Indications: xxx. Adverse reactions: xxx. Precautions and recommendations: xxx.”

Second round of interaction

“Amoxicillin and Clavulanate Potassium” is input by the user.

The platform parses the user’s request, retrieves an answer, and infers the interaction intent based on historical query for Amoxicillin and the scientific scenario.

The platform returns the answer and information source: “Amoxicillin and Clavulanate Potassium is a compound preparation composed of two components: amoxicillin and clavulanate potassium. It combines the advantages of both drugs to expand the antibacterial spectrum xxx. Mechanism of action: xxx. Indications: xxx. Adverse reactions: xxx. Precautions and recommendations: xxx.”

Third round of interaction

“Children’s test strip result: positive for rhinovirus; prescribed Amoxicillin and Clavulanate Potassium” is input by the user.

The platform parses the user’s request and retrieves an answer.

The user’s interaction intent is inferred, and the following information is first obtained.

“Conversation history: The queries mainly focus on the pharmacological properties of Amoxicillin and its compound preparation, as well as the reasons for applying this drug in pediatric rhinovirus infection and precautions.

Potential intent: Wants to comprehensively understand these two antibiotic drugs, as well as the rationality and precautions for their use in pediatric rhinovirus infection, thereby gaining further understanding and grasp of the doctor’s medication approach.

Emotional response: Reflect the concern and doubt of a parent or patient regarding drug use, hoping to obtain professional answers and guidance.

Platform strategy:

Express understanding and concern, convey comprehension and importance placed on the user’s doubts, use a friendly and amiable tone to make the user feel sincere attention. This helps establish a positive communication atmosphere.

Provide general information. Share general information about the drug, such as indications, mechanism of action, and common adverse reactions.

Emphasize adherence to medical advice. Objectively state that without confirmation from professionals, it is best to follow the doctor’s professional judgment and instructions, avoiding self-discontinuation or adjustment of medication.

Provide links to authoritative medical resources. The search engine can prioritize displaying official websites or articles from authoritative medical institutions in the results, such as Food and Drug Administration, Center for Disease Control and Prevention and hospitals. These resources can provide the user with accurate and credible drug information.

Online answers from professional doctors: Some medical consultation websites have doctors on online duty services. The search engine can aggregate answers from doctors on these websites regarding questions about the use of this drug, so as to provide professional opinions to the user.

Provide guidance and appointment registration portals for regular hospitals. If the user expresses a need for follow-up visit or return visit, provide official guidance and registration portals for local large general hospitals.

Online drug purchase services: For prescription-only drugs, do not recommend any online purchase channels due to safety and legality risks, and advise the user to go to local offline pharmacies or hospital pharmacies to purchase the drug.”

The platform returns the answer result and cited source: “For a child with a positive rhinovirus test result, the doctor may prescribe Amoxicillin and Clavulanate Potassium for the following considerations.

Prevention of secondary bacterial infection: After rhinovirus infection, the body’s defense decreases, making bacterial co-infections such as otitis media and pneumonia more likely. Amoxicillin and Clavulanate Potassium can effectively prevent and treat these bacterial infections.

Symptom relief: Although antibiotics are not required for viral colds, some complications caused by bacteria (e.g., sinusitis) may worsen symptoms. Amoxicillin can treat these bacterial infections, thereby relieving symptoms.

Condition assessment: Sometimes it is difficult for doctors to determine whether it is a pure viral infection or a bacterial infection, so preventive medication may be used based on symptoms and adjusted appropriately after further observation.

Child’s condition: If the child has low immunity or underlying diseases, the doctor may consider prophylactic use of antibiotics to prevent bacterial complications.

However, some doctors also believe that for common viral colds in children, excessive use of antibiotics is unnecessary. Therefore, parents can inquire with the doctor about the specific reason for medication, strictly follow the medical advice for drug use, and also pay attention to symptomatic supportive treatment, such as routine diet and rest. If symptoms do not alleviate or worsen, it is necessary to promptly follow up.

Simultaneously, related questions are recommended, i.e., additionally return online guidance consultation, local hospital registration, or local over-the-counter drug purchase service portals and question guidance.

(2) Interaction of inquiries about popular games

“Recent popular game ‘Game Name 1’” is input by the user.

The system searches the knowledge base and summarizes the answer retrieval result R1 as follows.

Link 1: “Recent very popular new games include ‘Game Name 1’. Brief introduction... It has received very positive feedback in terms of user reputation and download volume.”

Link 2: “Official website content of ‘Game Name 1’: xxx.”

Link 3: “Player community for ‘Game Name 1’: reviews and guides: xxx.”

The user intent is identified. Based on the user profile and request, marketing promotion information is retrieved, and the marketing search result R2 is summarized.

The system comprehensively sorts the cited sources of the answer retrieval result R1 and the marketing placement retrieval result R2 based on the link weights and the bidding price, and then returns the sorted result to the user as the cited source result A1. The original result R1 may be influenced by the result R2, leading to the following situations.

If R2 contains traffic-directing marketing placement on information sites (similar content), Link 1 is replaced with Link 1-1: “Recent very popular new games include ‘Game Name 1’. Brief introduction...”

If official marketing placement exists, Link 2 is the latest official placement link.

If same-category objects, rankings, or channel competition for traffic diversion exist, the third record of R1 may be affected and ranked lower. A1 returned to the user may be replaced with Link 3-1: “Introduction to products similar to ‘Game Name 1’ ... Rankings: xxx”

The system summarizes and integrates the cited source result A1 and the marketing placement retrieval result R2 to obtain the answer result A2 and returns the answer result A2 to the user. The summarization and integration are achieved based on the placement strategy of R2, including the following three types.

The system supplements additional information based on intent inference. Based on intent inference, the user profile “loves gaming”, possible intent “understand and experience the game” and the possible user service-type request intent, the system supplements the answer content with “the game can be downloaded and purchased for experience through the following legitimate channels: xxx”.

Extension and supplement of the latest official marketing scheme: In addition to the basic introduction of the original game, the latest game expansions or operational events are supplemented.

Expansion and replacement of same-category rankings, competing products, channel information and recommendation information: The experience/download link in the returned result is replaced with the “xx Bao” application download link.

The system integrates the user request Q, the answer result A2, and the marketing retrieval result R2, and can also integrate the following content, returned as recommended related questions A3 while returning inferred directly related possible questions, so as to guide the user in further multi-turn dialogues.

Service function guidance based on intent inference: Based on intent inference and the “understand and experience the game” request intent, the system supplements with service function docking interactive guidance questions, i.e., “‘Game Name 1’ download link”, “guides for ‘Game Name 1’”, and “what is the ‘Game Name 1’ player community?”.

Guidance questions for official marketing scheme: “Download for experiencing the latest expansion pack event of ‘Game Name 1’”.

Guidance questions for same-category rankings, competing products, channel information, and recommendation information: “genre of ‘Game Name 1’ and rankings of massive multiplayer online games (MMOs) in the same category”, and “reputation and experience of ‘Game Name 2’, a competing product of ‘Game Name 1’”.

The embodiments of the present disclosure have been described above. However, those of ordinary skill in the art should understand that the embodiments described above are merely illustrative of the present disclosure, and are not intended to limit the patent scope of the present in disclosure. Equivalent modifications and variations made by those skilled in the art without departing from the spirit and scope of the present disclosure shall fall within the scope of the present disclosure defined by the appended claims.

What is claimed is:

1. A large language model (LLM) interaction method, comprising:
(S1) acquiring a conversation input by a user, and parsing the conversation to obtain a user request;
(S2) performing retrieval and summarization according to the user request to obtain an answer retrieval result, wherein the answer retrieval result comprises a cited source link and a retrieved content; and
simultaneously performing comprehensive analysis on user personal setting information, third-party user profile information, historical dialogue information, a historical user intent and a current dialogue context followed by summarization and inference to obtain a current user intent; and based on the conversation and the current user intent, retrieving marketing placement information from a marketing database followed by summarization to obtain a marketing placement retrieval result, wherein the marketing placement retrieval result comprises a placement link, a placement content, a placement type and a placement strategy;
(S3) according to a link weight of the answer retrieval result, a link weight of the marketing placement retrieval result and a bidding price of the marketing placement retrieval result, performing comprehensive sorting on a cited source of the answer retrieval result and a cited source of the marketing placement retrieval result to obtain a sorted result, and returning the sorted result to the user as a cited source result;
(S4) performing summarization and integration on the cited source result and the marketing placement retrieval result to obtain an answer result, and returning the answer result to the user; and
(S5) integrating the user request, the answer result and the marketing placement retrieval result to obtain a recommended related question, and returning the recommended related question to the user to guide a further multi-turn dialogue.

2. The LLM interaction method of claim 1, wherein in step (S3), the comprehensive sorting comprises:
(a1) applicable to information site traffic guidance, when the user searches for certain information, increasing a link weight ranking among similar information;
(a2) applicable to official link protection and traffic direction, based on official information protection and distribution of a latest marketing scheme, ensuring that a result received by the user is latest official information; and
(a3) applicable to competitive traffic direction among same-category objects, rankings or channels, recommending same-category products or services while answering a user’s question.

3. The LLM interaction method of claim 1, wherein in step (S4), the summarization and integration are implemented based on the placement strategy, and comprise:
(b1) supplementing additional information based on intent inference;
wherein step (b1) is performed through a step of:
based on inference of the current user intent and a possible user service request intent, supplementing service function docking;
(b2) expanding and supplementing a latest official marketing scheme; and
(b3) expanding and replacing same-category rankings, competing products, channel information and recommendation information.

4. The LLM interaction method of claim 1, wherein in step (S5), the recommended related question is configured to integrate system-intent-based service function guidance, a guiding question for an official marketing scheme and a guiding question for same-category rankings, competing products, channel information and recommendation information.

5. An LLM interaction system, comprising:
a conversation parsing module;
a retrieval module;
a marketing placement module;
a first generation module;
a second generation module; and
a third generation module;
wherein the conversation parsing module is configured to acquire a conversation input by a user, and parse the conversation to obtain a user request;
the retrieval module is configured to perform retrieval and summarization according to the user request to obtain an answer retrieval result, and the answer retrieval result comprises a cited source link and a retrieved content;
the marketing placement module is configured to perform comprehensive analysis on user personal setting information, third-party user profile information, historical dialogue information, a historical user intent and a current dialogue context followed by summarization and inference to obtain a current user intent while the retrieval module performs retrieval, and retrieve marketing placement information from a marketing database followed by summarization to obtain a marketing placement retrieval result based on the conversation and the current user intent; and the marketing placement retrieval result comprises a placement link, a placement content, a placement type and a placement strategy;
the first generation module is configured to perform comprehensive sorting on a cited source of the answer retrieval result and a cited source of the marketing placement retrieval result to obtain a sorted result according to a link weight of the answer retrieval result, a link weight of the marketing placement retrieval result and a bidding price of the marketing placement retrieval result, and return the sorted result to the user as a cited source result;
the second generation module is configured to perform summarization and integration on the cited source result and the marketing placement retrieval result to obtain an answer result, and return the answer result to the user; and
the third generation module is configured to integrate the user request, the answer result and the marketing placement retrieval result to obtain a recommended related question, and return the recommended related question to the user to guide a further multi-turn dialogue.

6. The LLM interaction system of claim 5, wherein the comprehensive sorting comprises:
(a1) applicable to information site traffic guidance, when the user searches for certain information, increasing a link weight ranking among similar information;
(a2) applicable to official link protection and traffic direction, based on official information protection and distribution of a latest marketing scheme, ensuring that a result received by the user is latest official information; and
(a3) applicable to competitive traffic direction among same-category objects, rankings or channels, recommending same-category products or services while answering a user’s question.

7. The LLM interaction system of claim 5, wherein the summarization and integration are implemented based on the placement strategy, and comprise:
(b1) supplementing additional information based on intent inference;
wherein step (b1) is performed through a step of:
based on inference of the current user intent and a possible user service request intent, supplementing service function docking;
(b2) expanding and supplementing a latest official marketing scheme; and
(b3) expanding and replacing same-category rankings, competing products, channel information and recommendation information.

8. The LLM interaction system of claim 5, wherein the recommended related question is configured to integrate system-intent-based service function guidance, a guiding question for an official marketing scheme and a guiding question for same-category rankings, competing products, channel information and recommendation information.
